(19) United States
(12) Patent Application Publication
(10) Pub. No.: US 2008/0035169 A1
(43) Pub. Date: Feb. 14, 2008

(54) CLEANING MEANS FOR LARGE AREA PECVD DEVICES USING A REMOTE PLASMA SOURCE

(75) Inventors: Filippos Farmakis, Traklio Attikis (GR); Mustapha Elyaakoubi, Ris-Orangis (FR); Benoit Riou, Paris (FR); Emmanuil Choumas, Werdenberg (CH); Michael Irzyk, Melun (FR); Jozef Kudela, Nishinomiya-shi (JP)

Correspondence Address: PEARNE & GORDON LLP, 1801 EAST 9TH STREET, SUITE 1200, CLEVELAND, OH, 44114-3108, US

(73) Assignee: OC OERLIKON BALZERS AG, Balzers (LI)

(21) Appl. No.: 11/549,679

(22) Filed: Oct. 16, 2006

Related U.S. Application Data
(60) Provisional application No. 60/727,476, filed on Oct. 17, 2005.

(51) Int. Cl. B08B 6/00

(52) U.S. Cl. 134/1.1; 134/198

(57) ABSTRACT

This invention describes a method for cleaning a deposition chamber that is compatible with large area deposition. It comprises transport of activated gas from a remote plasma source to an area in the chamber in a uniform way through at least two injection points on equivalent paths for the reactive species. A respective gas injection system for the distribution of activated reactive gas comprises a source of reactive gas, a tubing for distributing the gas and an evacuable chamber. The gas is discharged to the tubing having at least one inlet constructively connected to the source and at least two outlets open to the chamber, thereby forming at least partially independent tube branches, wherein the length and the cross-section perpendicular to the gas flow of each tube branch, calculated between inlet and each respective outlet is essentially equal.

### BACKGROUND OF THE INVENTION

The present invention relates to the production of semiconductor layers in general and to the production of thin film transistors (TFT) in particular. A very common way to produce such TFTs is by using a plasma enhanced chemical vapor deposition (PECVD) process. A silicon containing precursor gas is being deposited on substrates with the ais of a plasma. Such semiconductors can be employed in different electronic devices such as in LCD displays, in solar cells or in organic light emitting diode (OLED's) displays among other applications. The production of LCD displays, for example, asks for high quality standards with regard to material properties of the deposits in terms of layer thickness and layer resistance homogeneity. During the deposition process unwanted film deposition on the reactor walls is unavoidable as it is not possible to coat solely the substrate. Hence, the film on the reactor walls would grow to the point that impurities in the form of particles are generated (“flaking”). These particles can drastically reduce the production yield, when they drop on the substrate during film deposition. Therefore it is common practice to clean the reactor before the substrate is accommodated on the reactor bottom. The layers on the reactor walls are wiped away and prevented from flaking off and from contaminating the semiconductor layers on the substrate. Two well known cleaning technologies are in-situ cleaning, where an etching plasma is ignited in the reactor and remote plasma source (RPS) cleaning. Especially RPS cleaning enjoys a wide popularity throughout the PECVD industry as it is very effective and helps to reduce throughput cycles. RPS cleaning works with fluorine or other halogen containing gases; they are introduced and dissociated within a remotely located plasma reactor. In a second step these highly aggressive radicals are introduced through a fluid connection to the main reactor, where they etch the semiconductor films attached to the reactor walls.

The problems in the Art as well as the solution according to the invention will be described in more detail with the aid of figures.

FIG. 1: Schematic of a one-point injection of reactive gas inside a PECVD chamber (Prior Art)

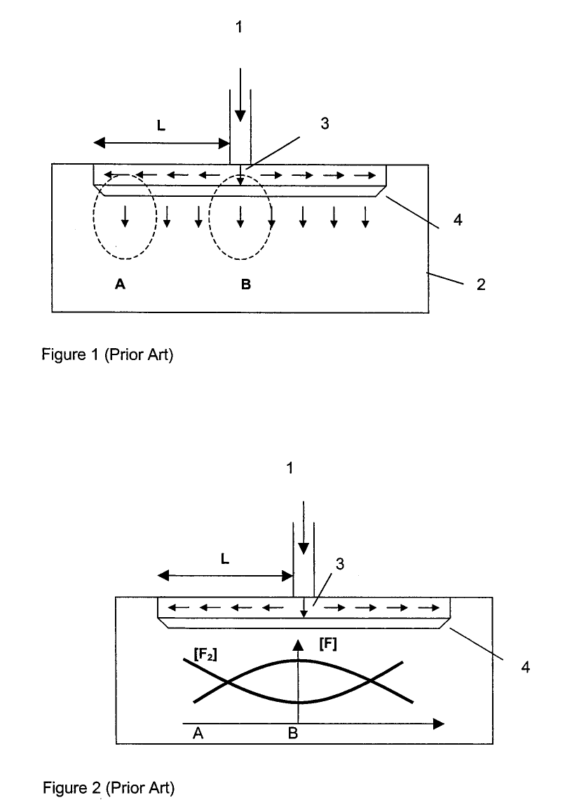

FIG. 2: Schematic of a one-point injection (Prior Art) of reactive gas inside a PECVD chamber. [F] and [F₂] profiles are demonstrated as a function of chamber length L.

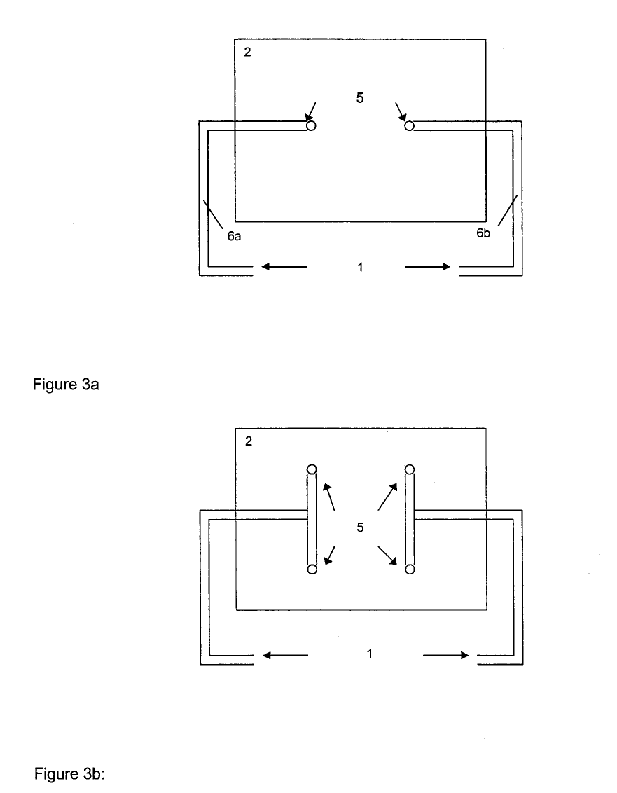

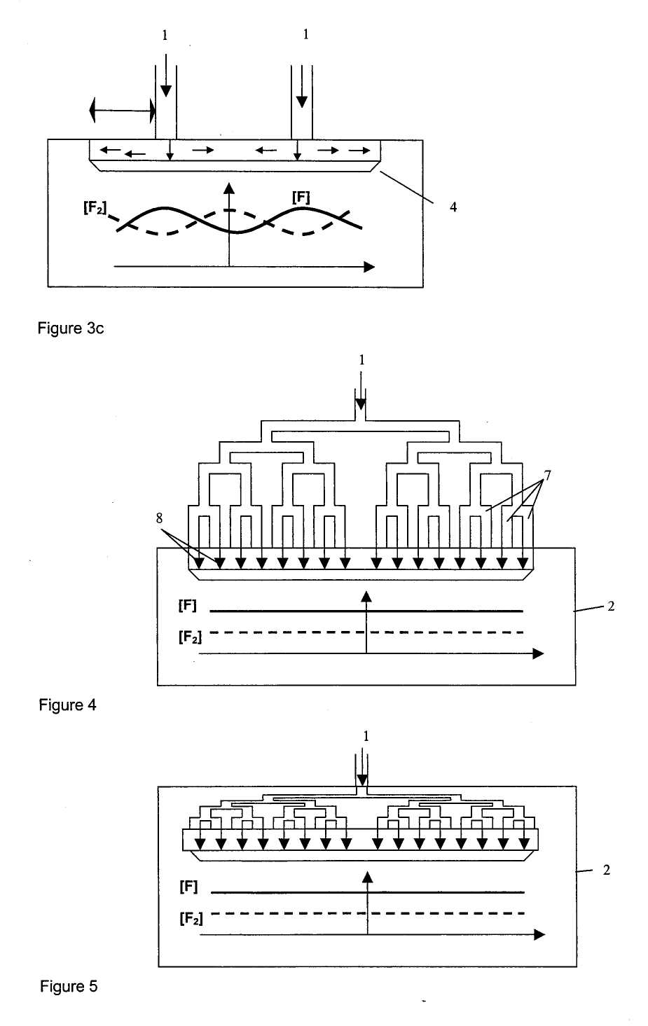

FIG. 3a: Schematic of two-point injection (embodiment of the invention). Top view.

FIG. 3b: Schematic of four-point injection (embodiment of the invention). Top view.

FIG. 3c: Schematic of a two-point injection (embodiment of the invention) of reactive gas inside a PECVD chamber. [F] and [F₂] profiles are shown as a function of chamber length in one axis.

FIG. 4: Schematic of reactive gas distribution through a net of multiples injection points outside the process chamber (embodiment of the invention). [F] and [F₂] profiles are demonstrated as a function of chamber length

FIG. 5: Schematic through spider (one embodiment) of reactive gas inside the PECVD chamber (common path with deposition gas). [F] and [F₂] profiles are demonstrated as a function of chamber length.

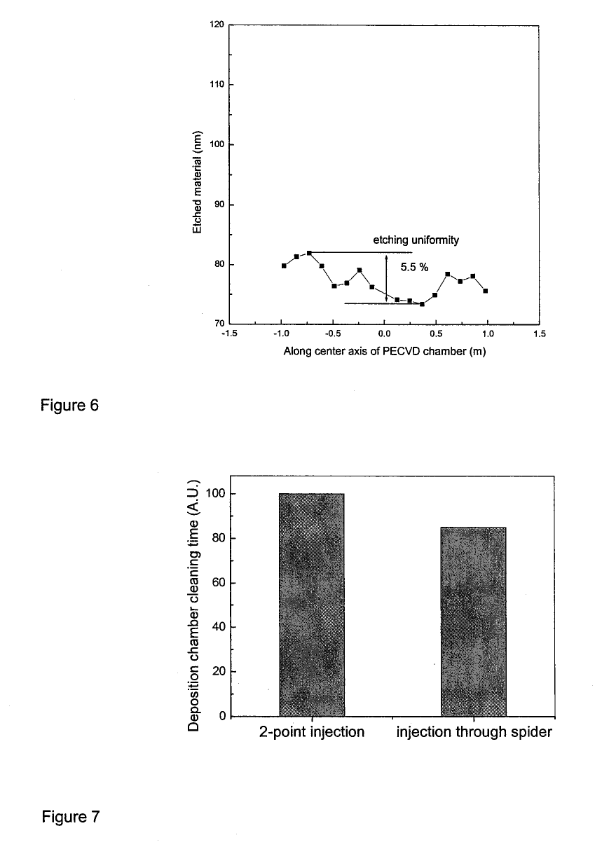

FIG. 6: Etched material as a function of the deposited area length. Spider injection was used. Etching uniformity is 5.5% over 2 m×2 m area.

FIG. 7: Total time needed to remove all deposits from PECVD chamber. More uniform injection (through spider) leads to reduced total cleaning time.

### DEFICIENCIES IN PRIOR ART

Cleaning of PECVD chambers prior to deposition of insulating (silicon dioxide, silicon nitride, silicon oxynitride) and semiconductor layers (amorphous silicon, microcrystalline and nano-crystalline) is a usual process step in the production. As semiconductor fabrication industry is highly concerned about reducing costs in its production lines, it becomes clear that any effort toward this direction is important. In Prior Art it is known to implement remote plasma sources for fluorine radicals outside the PECVD chamber and to direct this flux through pipes inside the chamber. However, these solutions are not fully compatible with large area PECVD tools in terms of equal gas distribution. With this respect, “large area” is to be understood as substrate size of 1 meter square or more.

In U.S. Pat. No. 4,820,377, No. 5,788,778, No. 6,274,058 B1, No. 2004/0200499 no attention has been paid to uniformity issues related to large area tools (e. g. dimensions more than 730×920 mm²). In Prior Art, exemplified in FIG. 1, one finds that (reactive) gas 1 is introduced inside the deposition chamber 2 through an injection point 3 and through a gas inlet manifold (or shower head) 4. With such configurations the fraction of the gas that flows to the extremities A of the deposited chamber covers a longer distance than the fraction that flows directly in the center B of the chamber It has to be noted that:

1. the distance covered from reactive species (gas) 1 in the gas inlet manifold (or shower head) 4 is free of deposits since deposition takes place between the parallel plates and the chamber walls,

2. it is known that recombination of reactive species occurs during reactive gas flow. Aside from other parameters (temperature, pressure, material, etc.) (K. Iskenderova Thesis at Drexel University, “Cleaning Process in High Density Plasma Chemical Vapor Deposition Reactor”, October 2003) recombination depends mainly on distance. Recombined species are much less reactive with silicon based materials.

Above mentioned points indicate that reactive species 1 flowing to the extremities of the chamber A become less reactive due to the longer distance (i.e. more recombined species). Interpreting the previous statement in terms of cleaning rate, at the edges of the chamber deposited material will be removed in a lower rate than material in the middle of the chamber. These two facts lead to a non-uniform etching rate throughout the deposited chamber, decreasing overall cleaning rate and thus the throughput of the system. Semiconductor industry for flat panel displays moving forward to larger chamber; this difference in the cleaning rate (between edges and center) becomes more important.

To overcome non-uniform distribution of fluorine in the chamber, U.S. Pat. No. 6,828,241 B2 proposes additional application of RF power in the deposition chamber. By this means re-activation of recombined radicals takes place and more uniform distribution is achieved due to the introduction of a carrier gas such as He. However, the main disadvantages of in-situ RF cleaning re-appear: hardware damage due to ion bombardment and the creation of Aluminum Fluoride AlxFy layer on deposition chamber's kit components.

### SOLUTIONS ACCORDING TO THE INVENTION

This invention concerns a method for cleaning a deposition chamber that is compatible with large area deposition. It comprises transport of activated gas from a remote plasma source to a deposited area in the chamber in a uniform way through multiple injection points (at least two) and assuming an equivalent path for reactive species.

The invention is best described as a gas injection system for the distribution of (activated) reactive gas, comprising a source of reactive gas, a tubing for distributing the gas and an evacuable chamber. The gas is discharged to the tubing having at least one inlet constructively connected to the source and at least two outlets open to the chamber, thereby forming at least partially independent tube branches, wherein the length and the cross-section perpendicular to the gas flow of each tube branch, calculated between inlet and each respective outlet is essentially equal.

Each tube branch may be composed by a network of piping with various diameters, but finally the total piping network should be symmetrical for the gas injection. In other words, gas flowing from the outlet of a RPS to each inlet of vacuum chamber can “see” a series of “pipes” (circular, rectangular, etc.) having different cross-sections. Of course these cross-sections need to be essentially equal between each branch so as to have the same impedance.

Mixture of etching gas and/or carrier gas is introduced in the remote plasma source, where activation of gas takes place. At the output of the remote plasma source activated radicals are flowed through a system of tubing (preferably anodized Aluminum) to the deposition chamber. In atmospheric or vacuum environment, activated species are divided to at least two equivalent paths. Each portion of reactive gas is flowed in the chamber through inlet ports adapted in the process chamber. Inlet port spatial arrangement is determined by deposition chamber dimension and the amount of various paths. In all cases, each portion of reactive gas should reach the deposited area by equivalent paths in terms of material, temperature, length, diameter, pipe configuration, pressure drop.

Taking the example of fluorine based gas; reactive gas at the output of the remote plasma source contains a very large amount of atomic fluorine F with inert gas by-products and a slight amount of molecular fluorine F₂. Reactive species (in this case atomic fluorine) are generally recombined in a third-body reaction according to the formula:
F+F+M=>F₂+M

It is generally know that atomic fluorine F etches more drastically silicon-based materials than F₂ and/or other possible by-products resulting from minor chemical recombination. In other words, cleaning rate is more related to the atomic fluorine concentration [F]. In the previous section we discussed that in prior art that [F] and [F₂] inside the deposited area of the chamber depends on position, as shown in FIG. 2. It can be easily concluded that [F] at the chamber extremity A is lower (and [F₂] higher) than at the center B. This fact leads to a difference in local cleaning rate that affects total cleaning time.

This invention improves cleaning uniformity throughout the whole deposited area in the chamber decreasing the ratio [F]/[F₂] difference between edge and center of the deposited area in the chamber. In a uniformly heated chamber, etching uniformity can be defined as [F] concentration uniformity throughout the deposited area in the chamber. As examples for the present invention, four possible embodiments are shown (FIGS. 3 and 4). In all cases, [F] distribution within the deposited area is more uniform than in prior art.

FIG. 3a demonstrates a two-point injection. Reactive species/reactive gas 1 generated in a remote plasma source are divided in two equivalent paths 6a, 6b and then injected via injection points 5 in the process chamber 2, where prior deposition occurred. FIG. 3b shows a four-point injection configuration where a even more uniform reactive gas distribution takes place. In a multiple-point injection (FIG. 4), reactive gas 1 is flowing through multiple equivalent paths 7 (selection) and then it is injected via injection points 8 (selection) into the process chamber 2. Choice of the appropriate configuration and the number of injection points could depend on the chamber design, on gas pressure in the piping and generally should be a compromise between uniformity of injected gas and recombination rate of reactive species.

In another possible embodiment shown in FIG. 5, where injection is achieved through a so called gas spider, etchant gas reaches deposited area through multiple equivalent paths. In this case reactive gas flows through equivalent paths, so that all over the deposited area, same [F] concentration has to be found. Experiments conducted in KAI3000 PECVD system demonstrated that etching uniformity attains less than 6% level (FIG. 6) which results in faster cleaning rate of the deposited chamber. Comparing time needed to remove all deposited material in the chamber, more uniform distribution (injection through spider) leads to reduced total cleaning time. (FIG. 7). Furthermore, reduced total cleaning time leads to lower gas consumption which represents an important feature for industrial applications. Finally, we assume that one-point injection (prior art) should give the worst results.

### FURTHER ADVANTAGES OF THE INVENTION

Regarding the geometry of the reactor, several possible designs may be applied. To all these designs, the main idea is that reactive gas is reaching deposited area through more than one equivalent path. Number and distribution of paths can be modified according to the geometry of the deposited area, the nature of deposits and their profile in the PECVD chamber.

Moreover, another advantage of the invention relies on the fact that it can be applied to more than one deposition chamber fed from one Remote Plasma Source. Indeed, if equivalent radical's path is respected, uniform cleaning can be achieved in more than one chamber. Cleaning gas injection in each chamber should be also taken into consideration as mentioned above.

Finally, application of the present invention to PECVD deposition chambers requires slight modification of the existing hardware. Piping adjustment after gas distribution calculation is needed. In the case that the existing system is already composed of a spider gas divider, then a connection of cleaning gases to the main gas pipe (deposition gases) may be sufficient.

1. A method for cleaning a vacuum deposition construed for substrates of 1 meter square or more, the method comprising: transport of activated gas from a remote plasma source into the chamber in a uniform way through at least two injection points, wherein the path for the activated gas is equivalent.

2. Method according to claim 1 wherein said equivalent paths are equivalent in terms of material, temperature, length, diameter, pipe configuration or pressure drop.

3. Method according to claim 1 wherein said remote plasma source is being operatively connected to several vacuum deposition chambers for parallel cleaning action.

4. A gas injection system for the distribution of activated reactive gas in a vacuum deposition chamber construed for substrates of 1 meter square or more comprising a source of reactive gas, a remote plasma source for activating said reactive gas, a tubing for distributing said gas, said tubing having at least one inlet constructively connected to the source and at least two outlets open to the chamber, thereby forming at least partially independent tube branches, wherein the length and the cross-section perpendicular to the gas flow of each tube branch, calculated between inlet and each respective outlet is essentially equal.

5. Gas injection system according to claim 4, wherein each tube branch comprises a network of piping with various diameters, each branch being symmetrical for the gas injection and having essentially the same impedance.
